(19) United States
(12) Patent Application Publication
(10) Pub. No.: US 2009/0303924 A1
(43) Pub. Date: Dec. 10, 2009

(54) PACKET DATA NETWORK SELECTION

(75) Inventors: Basavaraj Patil, Coppell, TX (US); Gyorgy Wolfner, Budapest (HU); Domagoj Premec, Zagreb (HU)

Correspondence Address: BRAKE HUGHES BELLERMANN LLP, c/o CPA Global, P.O. BOX 52050, MINNEAPOLIS, MN, 55402, US

(73) Assignee: Nokia Siemens Networks Oy, Espoo (FI)

(21) Appl. No.: 12/136,501

(22) Filed: Jun. 10, 2008

(51) Int. Cl. H04W 4/00; H04L 12/56

(52) U.S. Cl. 370/328; 370/389

(57) ABSTRACT

According to an example embodiment, a method may include sending, by a mobile station in a wireless network, a dynamic service addition (DSA) message to a base station, the DSA message identifying a packet data network (PDN) by access point name (APN). The method may further include exchanging data with the indicated packet data network via the base station.

### TECHNICAL FIELD

This description relates to wireless networks.

### BACKGROUND

Mobile stations may establish an air interface with a base station. The base station may be connected to one or more backhaul networks.

### SUMMARY

According to an example embodiment, a method may include sending, by a mobile station in a wireless network, a dynamic service addition (DSA) message to a base station, the DSA message identifying a packet data network (PDN) by access point name (APN). The method may further include exchanging data with the indicated packet data network via the base station.

According to another example embodiment, an apparatus may include a controller, a wireless transceiver, and a memory. The controller may be configured to generate a dynamic service addition (DSA) message, the DSA message identifying a packet data network (PDN) by access point name (APN). The controller may be further configured to process data to be exchanged with the indicated packet data network via a base station. The wireless transceiver may be configured to send the DSA message to the base station and to send and receive the data to and from the base station.

According to another example embodiment, a method may include receiving, by a base station from a mobile station in a wireless network, a dynamic service addition (DSA) message, the DSA message identifying a packet data network (PDN) by access point name (APN). The method may further include sending a data path (DP) message to a gateway, the DP message including the APN. The method may further include receiving and forwarding data between the mobile station and the PDN identified by the APN.

According to another example embodiment, an apparatus may include a controller, a transceiver, and a memory. The controller may be configured to process a dynamic service addition (DSA) message, the DSA message identifying a packet data network (PDN) by access point name (APN). The controller may be further configured, based on processing the DSA message, to generate a data path (DP) message to a gateway, the DP message including the APN. The controller may be further configured to receive and forward data between a mobile station and the PDN identified by the APN. The transceiver may be configured to receive the DSA message from the mobile station and receive and send data from and to the mobile via a wireless interface, and receive and send data from and to the PDN.

According to another example embodiment, a method may include receiving, by a gateway, a data path message from a base station serving a wireless network, the data path message including a network access identifier (NAI) identifying a mobile station served by the base station. The method may further include determining a packet data network (PDN) to serve the mobile station based on the NAI. The method may further include mapping the determined PDN to an access point node (APN). The method may further include establishing a connection between the mobile station and the APN via the base station and the gateway.

The details of one or more implementations are set forth in the accompanying drawings and the description below. Other features will be apparent from the description and drawings, and from the claims.

### BRIEF DESCRIPTION OF THE DRAWINGS

FIG. 1A is a diagram showing a wireless network, an access service network, evolved packet core networks, and packet data networks according to an example embodiment.

FIG. 1B is a diagram showing a mobile station receiving user input according to an example embodiment.

FIG. 2A is a timing diagram showing establishment of a connection between a mobile station (MS) and a packet data network (PDN) gateway (GW) according to an example embodiment in which the access service network initiates service flow establishment.

FIG. 2B is a timing diagram showing establishment of a connection between the mobile station (MS) and the packet data network (PDN) gateway (GW) according to an example embodiment in which the mobile station initiates service flow establishment.

FIG. 2C is a timing diagram showing establishment of a connection between a mobile station (MS) and a packet data network (PDN) gateway (GW) according to another example embodiment.

FIG. 3A is a block diagram showing a dynamic service addition (DSA) message according to an example embodiment.

FIG. 3B is a block diagram showing a payload included in the DSA message of FIG. 3A according to an example embodiment.

FIG. 4 is a flowchart showing a method according to an example embodiment.

FIG. 5 is a flowchart showing a method according to another example embodiment.

FIG. 6 is a flowchart showing a method according to another example embodiment.

FIG. 7 is a block diagram showing an apparatus according to an example embodiment.

### DETAILED DESCRIPTION

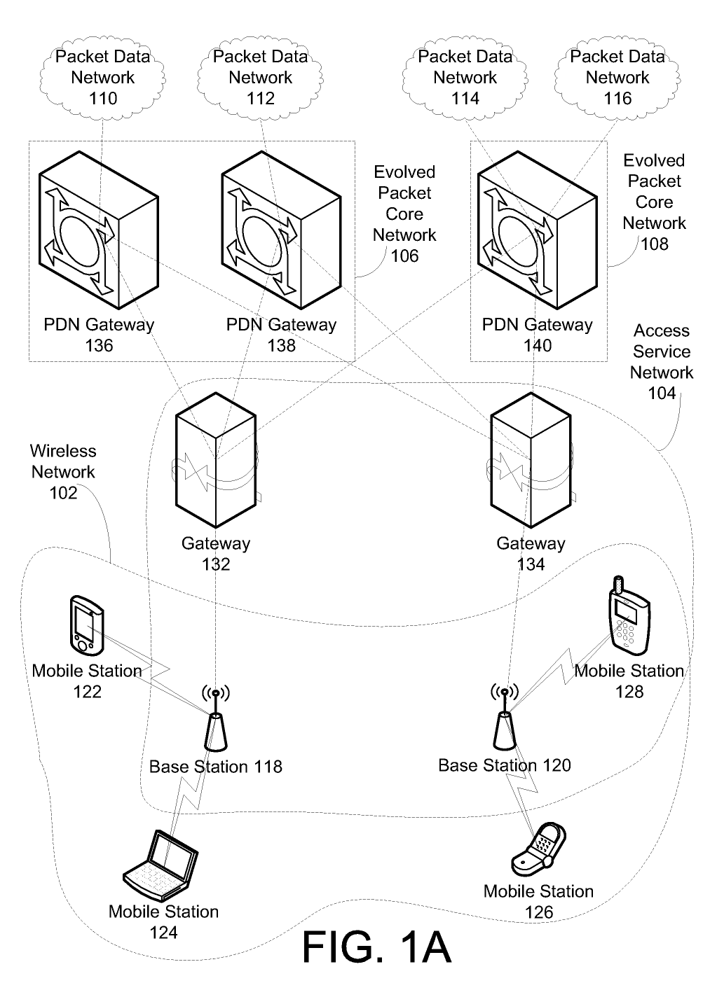

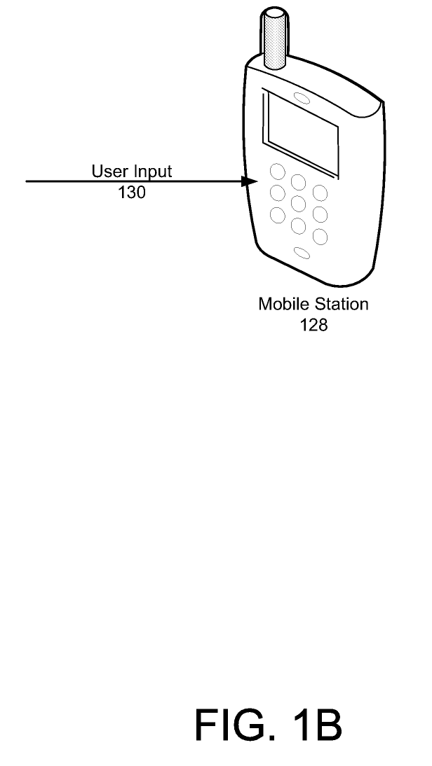

FIG. 1A is a diagram showing a wireless network 102, an access service network 104, evolved packet core networks 106, 108, and packet data networks 110, 112, 114, 116 according to an example embodiment. The wireless network 102 may include, for example, an IEEE 802.16 based Worldwide interoperability for Microwave Access (WiMAX) network.

The wireless network 102 may include one or more base stations 118, 120. The base stations 118, 120 may, for example, include WiMAX base stations. The base stations 118, 120 may be connected to the access service network (ASN) 104 via a wired or wireless connection, according to example embodiments. The ASN 104 may, for example, include a WiMAX access service network. Each of the base stations 118, 120 may serve one or more mobile stations 122, 124, 126, 128. The mobile stations 122, 124, 126, 128 may, for example, include personal digital assistants (PDAs), laptop or notebook computers, cellular telephones, or smartphones, according to example embodiments.

The base stations 118, 120 may communicate with the mobile stations 122, 124, 126, 128 via an air interface. The base stations 118, 120 may communicate with the mobile stations 122, 124, 126, 128 directly via the air interface, or may communicate with the mobile stations 122, 124, 126, 128 via one or more relay stations (not shown). The relay stations, if used, may communicate with each other and/or with the mobile stations 122, 124, 126, 128 and base stations 118, 120 via the air interface. The relay stations may forward data and/or messages between the base stations 118, 120 and the mobile stations 122, 124, 126, 128. As used in this description, when the base stations 118, 120 and mobile stations 122, 124, 126, 128 send and receive messages from each other, the messages may be sent and received directly between the base stations 118, 120 and mobile stations 122, 124, 126, 128 via the air interface, or via one or more relay stations.

When a mobile station 122, 124, 126, 128 enters the wireless network 102, the mobile station 122, 124, 126, 128 may engage in an initialization procedure with the respective base station 118, 120. The mobile station 122, 124, 126, 126, 128 may enter the wireless network 102 upon being powered on, or upon physically moving within range of the base station 118, 120, according to example embodiments. The mobile station 122, 124, 126, 128 may, for example, consult a frequency list stored in its memory, and search on one or more of the channels in the frequency list for a frame preamble transmitted by a base station 118, 120. If the mobile station 122, 124, 126, 128 finds the preamble, the mobile station 122, 124, 126, 128 may determine the base station's 118, 120 downlink transmission parameters and synchronize with the base station 118, 120.

The mobile station 122, 124, 126, 128 may also engage in initial ranging with the base station 118, 120. The mobile station 122, 124, 126, 128 may, for example, adjust its transmission timing and transmission power for communication with the base station 118, 120. The base station 118, 120 may allocate basic and primary management connection identifiers (CIDs) to the mobile station 122, 124, 126, 128.

The mobile station 122, 124, 126, 128 may also negotiate basic capabilities with the base station 118, 120. The mobile station 122, 124, 126, 128 and the base station 118, 120 may, for example, negotiate fundamental medium access control (MAC) and physical layer (PHY) features, such as maximum transmission power, modulation schemes, forward error correction (FEC) codes, and/or support of MAC bandwidth allocation schemes, according to example embodiments.

The mobile station 122, 124, 126, 128 may also authenticate itself to the base station 118, 120, such as by engaging in an authorization protocol with the base station 118, 120. The authorization protocol may, for example, include sending an authentication information privacy key management version 2 (PKMv2) message to the base station 118, 120. The mobile station 122, 124, 126, 128 may also send an authorization request message including a certificate to the base station 118, 120. The base station 118, 120 may authenticate the certificate, and the base station 118, 120 and mobile station 122, 124, 126, 128 may establish a security association (SA) and exchange traffic encryption keys.

The mobile station 122, 124, 126, 128 may register with the base station 118, 120, which may include negotiating an Internet Protocol (IP) version and quality of service parameters. The mobile station 122, 124, 126, 128 may also acquire an IP address from the base station 118, 120.

The mobile station 122, 124, 126, 128 may determine a packet data network (PDN) with which to communicate. The PDN may include, for example, the Internet, an enterprise network, such as a network operated by a user's employer or place of business, or an IP Multimedia System (IMS) network. The mobile station 122, 124, 126, 128 may determine the PDN based, for example, on receiving input from a user of the mobile station 122, 124, 126, 128. FIG. 1B is a diagram showing a mobile station 122, 124, 126, 128 receiving user input 130 according to an example embodiment. The user input may or may not directly indicate the PDN or APN. The user input 130 may indicate a desired application or task for the mobile station 122, 124, 126, 128 to perform, and the mobile station 122, 124, 126, 128 may map the application or task to a PDN or APN. An application may be preconfigured or provisioned to use a specific PDN, and an APN associated with the PDN may be preconfigured on the mobile station 122, 124, 126, 128. The user may select an application, and the mobile station 122, 124, 126, 128 may determine the APN and/or PDN based on the selected application. For example, if the user clicks on a web browser icon, the mobile station 122, 124, 126, 128 may determine that the PDN should be the Internet. If the user clicks on a corporate email icon, the mobile station 122, 124, 126, 128 may determine that the PDN should be an enterprise network. If the user clicks on a video or audio icon, the mobile station 122, 124, 126, 128 may determine that the PDN should be an IMS network.

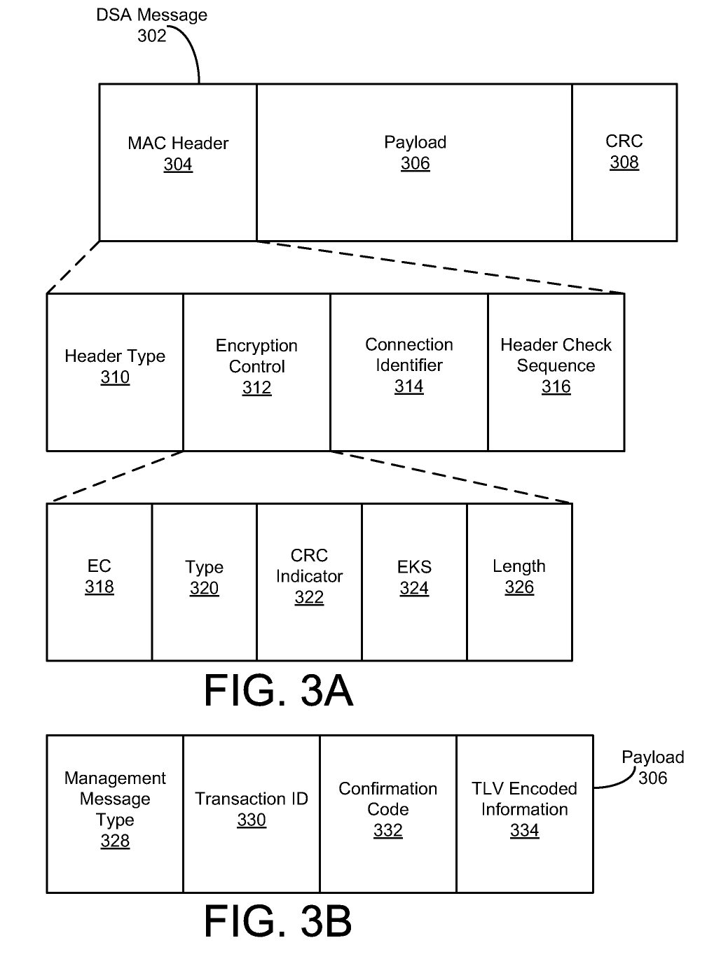

Referring back to FIG. 1A, after or during entering and initializing with the base station 118, 120, the mobile station 122, 124, 126, 128 may send a dynamic service addition (DSA) message to the base station 118, 120. The DSA message, which is described in further detail with reference to FIGS. 3A and 3B, may identify a PDN by APN. The APN may map to a PDN. The DSA message may, for example, include the PDN determined by the mobile station 122, 124, 126, 128.

The DSA message may, for example, include either a DSA request or a DSA response. In an example in which the mobile station 122, 124, 126, 128 initiates a service flow establishment, the mobile station 122, 124, 126, 128 may send a DSA request to the base station 118, 120. In response to receiving the DSA request, the base station 118, 120 may send a DSA response to the mobile station 122, 124, 126, 128 confirming and/or acknowledging the request.

In an example in which the base station 118, 120 initiates the service flow establishment, the base station 118, 120 may send a DSA request to the mobile station 122, 124, 126, 128. The DSA request may include a request for a PDN. The mobile station 122, 124, 126, 128 may, in response to receiving the DSA request, send a DSA response to the base station 118, 120. The DSA response may include the APN which identifies the PDN.

The base stations 118, 120 may be included in the access service network (ASN) 104. The ASN 104 may include a wired infrastructure network which provides data to the base stations 118, 120. The ASN may include the base stations 118, 120, as well as one or more ASN gateways 132, 134. The ASN gateways 132, 134 may each serve one or more base stations 118, 120 via a wired or wireless interface.

Upon entry of a mobile station 122, 124, 126, 128 into the wireless network 102, the serving base station 118, 120 may engage in a network entry procedure with its respective serving ASN gateway 132, 134. The serving base station 118, 120 may, for example, exchange attachment messages with its serving ASN gateway 132, 134. The serving base station 118, 120 may, for example, include context information and/or identification information for the mobile station 122, 124, 126, 128 and/or serving base station 118, 120 in an attachment message sent to the serving ASN gateway 132, 134. The serving base station 118, 120 may also authenticate the mobile station 122, 124, 126, 128 to the serving ASN gateway 132, 134 by exchanging authentication request messages with the ASN gateway 132, 134, according to an example embodiment.

In an example embodiment, the serving base station 118, 120 may establish a generic routing encapsulation (GRE) tunnel between the serving base station 118, 120 and the serving ASN gateway 132, 134. The combination of the air interface between the mobile station 122, 124, 126, 128 and the serving base station 118, 120 (which may or may not include relay stations) and the GRE tunnel between the serving base station 118, 120 and the serving ASN gateway may form a service flow between the mobile station 122, 124, 126, 128 and the serving ASN gateway 132, 134.

Establishing the GRE tunnel may include exchanging data path (DP) messages between the serving base station 118, 120 and the serving ASN gateway 132, 134. For example, the serving base station 118, 120 may send a DP message to the serving ASN gateway. The DP message may include the APN identifying the PDN that the base station 118, 120 received from the mobile station 122, 124, 126, 128.

In an example in which the mobile station 122, 124, 126, 128 initiated the exchange of DSA messages, the DP message sent by the serving base station 118, 120 may include a DP request. The base station 118, 120 may send the DP request to the serving ASN gateway 132, 134 in response to receiving the DSA request from the mobile station 122, 124, 126, 128. The serving ASN gateway 132, 134 may send a DP response to the serving base station 118, 120, thereby establishing the GRE tunnel, in response to receiving the DP request. In response to receiving the DP response from the serving ASN gateway 132, 134, the base station 118, 120 may send a DSA response to the mobile station 122, 124, 126, 128.

In an example in which the serving ASN gateway 132, 134 initiates the request, the serving ASN gateway 132, 134 may send a DP request to the serving base station 118, 120. In response to receiving the DP request from the serving ASN gateway 132, 134, the serving base station 118, 120 may send a DSA request to the mobile station 122, 124, 126, 128. The mobile station 122, 124, 126, 128 may respond to the DSA request by sending the DSA response identifying the PDN by APN to the serving base station 118, 120. In response to receiving the DSA response from the mobile station 122, 124, 126, 128, the serving base station 118, 120 may send the DP message, which may include a DP response, to the serving ASN gateway 132, thereby establishing the GRE tunnel.

The ASN gateways 132, 134 may be connected via wired and/or wireless connections to the EPC networks 106, 108, and/or to an access authentication authorization (AAA) server (not shown in FIG. 1A). During the entry and initialization of the mobile station 122, 124, 126, 128, the serving ASN gateway 132, 134 may communicate with the AAA server to authorize the mobile station 122, 124, 126, 128 to operate within the wireless network 102.

The EPC networks 106, 108 may serve as interfaces to the PDNs 110, 112, 114, 116. Each EPC network 106, 108 may include one or more PDN gateways (or access point nodes (APNs)) 136, 138, 140. Each PDN gateway 136, 138, 140 may be associated with, and serve as an interface to, one or more PDN networks 110, 112, 114, 116. Each of the ASN gateways 132, 134 may be connected to one or more PDN gateways 136, 138, 140, and thereby have access to the PDNs 110, 112, 114, 116 with which the respective PDN gateways 136, 138, 140 are associated. The ASN gateways 132, 134 may communicate with the PDN gateways 136, 138, 140 using, for example, proxy mobile Internet Protocol (IP) version 6.

The ASN gateways 132, 134 may store associations between the PDN gateways 136, 138, 140 and the PDNs 110, 112, 114, 116. Upon receiving the DP message including the APN from the serving base station 118, 120, the serving ASN gateway 132, 134 may map the APN to a PDN associated with a PDN gateway 136, 138, 140 or access point node (APN). The serving ASN gateway 132, 134 may establish a connection between the mobile station 122, 124, 126, 128 which was indicated by the base station 118, 120 and the mapped PDN gateway 136, 138, 140 or APN via the serving base station 118, 120 and the serving ASN gateway 132, 134.

In an example in which the mobile station 122, 124, 126, 128 does not identify the PDN 110, 112, 114, 116 from which it should receive service (such as by identifying the PDN 110, 112, 114, 116 by APN), the serving ASN gateway 132, 134 may determine which PDN 110, 112, 114, 116 should provide service to the mobile station 122, 124, 126, 128 based on an identity of the mobile station 122, 124, 126, 128. The identity of the mobile station 122, 124, 126, 128 may include, for example a network access identifier (NAI). In an example embodiment, the serving ASN gateway 132, 134 may store an association between identities such as NAIs and PDNs 110, 112, 114, 116. The data path message that the serving ASN gateway 132, 134 receives from the serving base station 118, 120 may include the identity, such as the NAI, of the mobile station 122, 124, 126, 128. The serving ASN gateway 132, 134 may determine which PDN 110, 112, 114, 116 should provide service to the mobile station 122, 124, 126, 128 based on the identity such as the NAI. The serving ASN gateway 132, 134 may map the determined PDN to the PDN gateway 136, 138, 140 or APN, and establish a connection between the mobile station 122, 124, 126, 128 and the PDN gateway 136, 138, 140 or APN via the serving base station 118 and the ASN gateway 132, 134, according to an example embodiment.

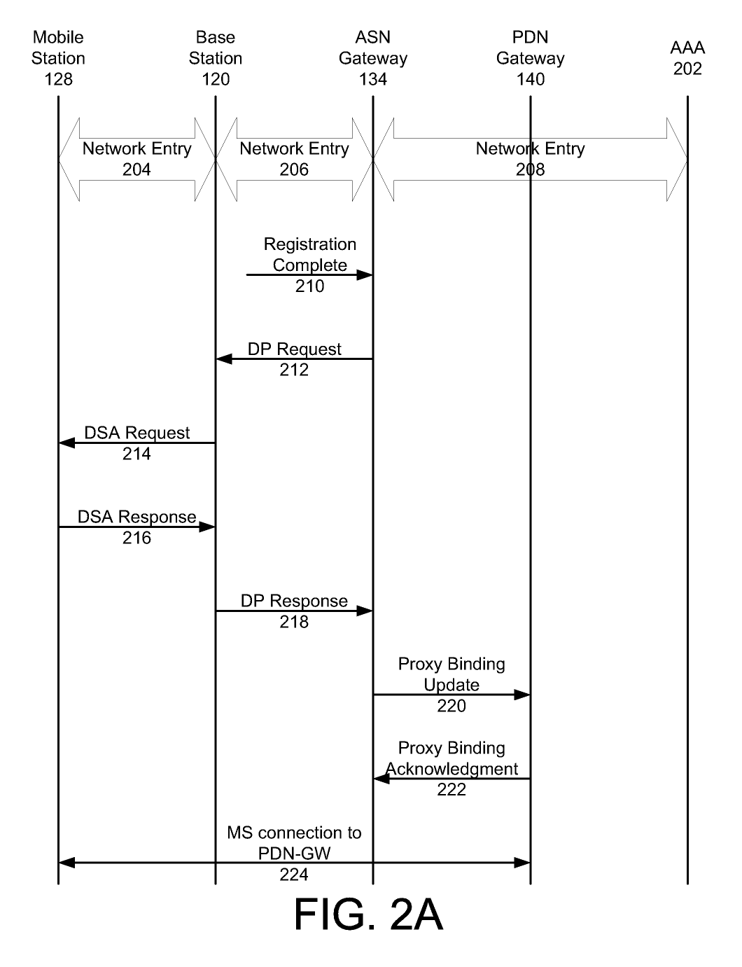

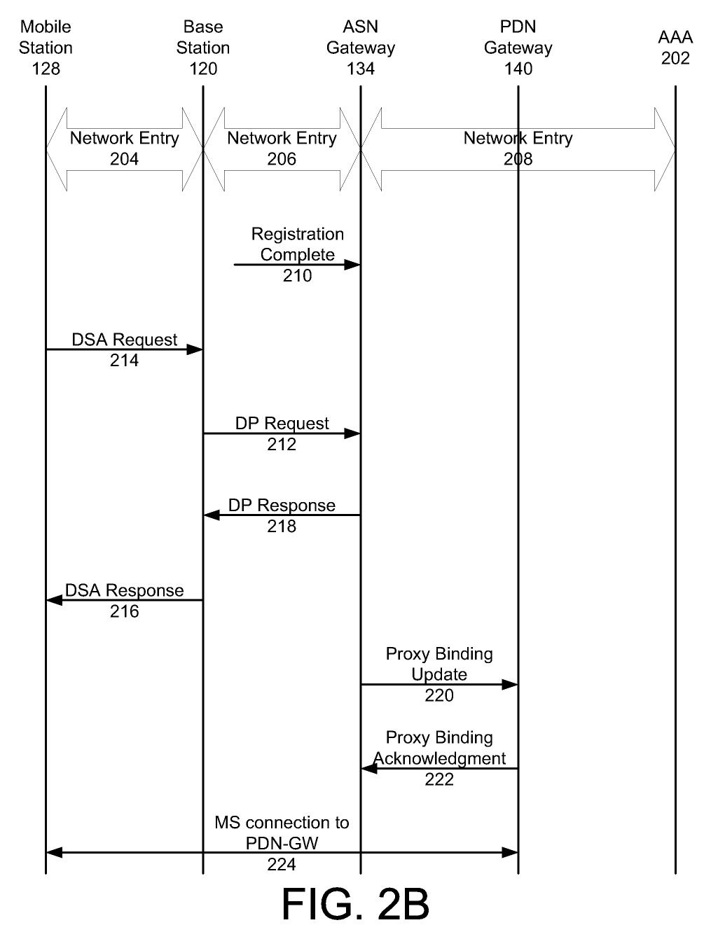

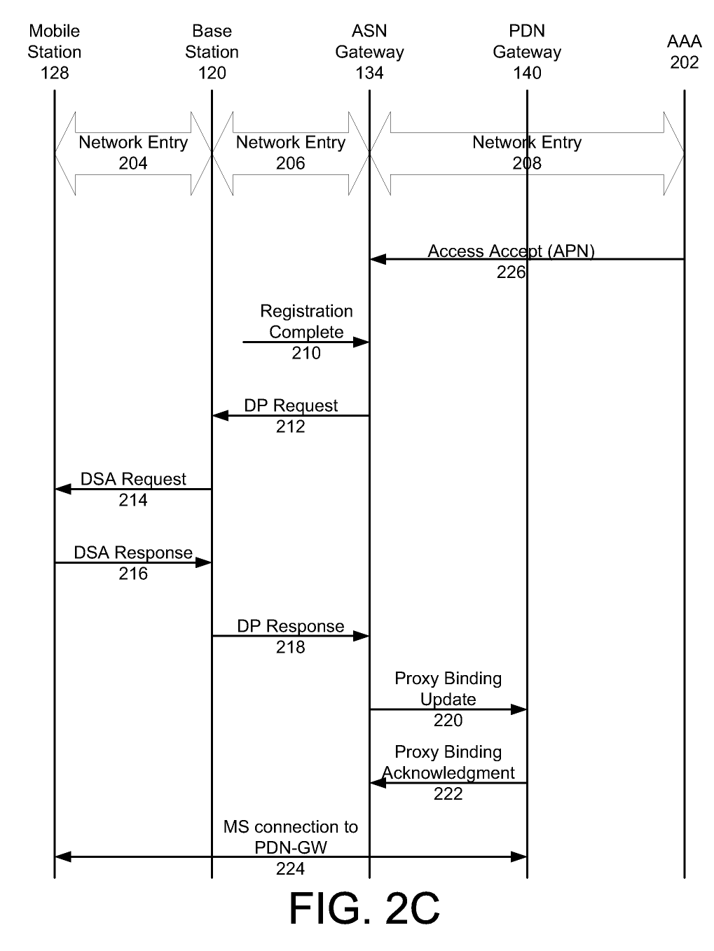

FIG. 2A is a timing diagram showing establishment of a connection between a mobile station (MS) 128 and a packet data network (PDN) gateway (GW) 140 according to an example embodiment in which the access service network 104 initiates service flow establishment. In this example, the mobile station 128 may engage in network entry (204) with the base station 120 as described in paragraphs [0023] through [0027]. Based on the mobile station's 128 network entry (204), the base station 120 may engage in network entry (206) with the ASN gateway 134 as described in paragraph [0033]. Based on the base station's 120 network entry (208), the ASN gateway 134 may engage in network entry (208) with the AAA server 202 to authenticate the mobile station 128. The registration of the mobile station 128 may then be considered complete (210).

In the example shown in FIG. 2A, in which the ASN gateway 134 may initiate the service flow establishment, the ASN gateway 134 may send a DP request 212 to the base station 120. In response to receiving the DP request 212 from the ASN gateway, the base station may send a DSA request 214 to the mobile station 128. The mobile station 128 may respond to receiving the DSA request 214 by sending a DSA response 216 to the base station 120. The DSA response 216 may include the APN as an attribute; the APN may map to the PDN with which the mobile station 128 should be associated. In response to receiving the DSA response 216 from the mobile station 128, the base station 120 may send a DP response 218 to the ASN gateway 134, establishing the GRE tunnel. The DP response may include the APN which maps to the PDN The ASN gateway 134 may map the PDN to the PDN gateway 140, and may send a proxy binding update 220 to the PDN gateway 140. The proxy binding update 220 may indicate the association between the mobile station 128 and the PDN gateway 140. In response to receiving the proxy binding update 220, the PDN gateway 140 may send a proxy binding acknowledgment 222 to the ASN gateway 134, acknowledging successful receipt of the proxy binding update 220 and confirming that the PDN gateway 140 may associate with the mobile station 128. The mobile station 128 may then be connected to the PDN gateway 140 which is identified by the APN requested by the mobile station (224).

FIG. 2B is a timing diagram showing establishment of a connection between the mobile station (MS) 128 and the packet data network (PDN) gateway (GW) 140 according to another example embodiment in which the mobile station 128 initiates service flow establishment. In this example, the mobile station 128 may initiate the service flow establishment, and the mobile station 128 may send the DSA request 214 to the base station 120. The DSA request 214 may include the APN as an attribute; the APN may map to the PDN with which the mobile station 128 should be associated. The base station 120 may send the DP request 212 to the ASN gateway 134 in response to receiving the DSA request 214. In response receiving the DP request 212 from the base station 120, the ASN gateway 134 may send the DP response to the base station 120, establishing the GRE tunnel. The base station 120 may send the DSA response 216 to the mobile station 128 in response to receiving the DP response 218 from the ASN gateway 134.

FIG. 2C is a timing diagram showing establishment of a connection between the mobile station (MS) 128 and the packet data network (PDN) gateway (GW) 140 according to another example embodiment. In this example, the mobile station 128 may not indicate a PDN, and the ASN gateway 134 may determine a PDN to associate the mobile station 128 with a PDN based on an identity of the mobile station 128, such as the NAI of the mobile station 128. The ASN gateway 134 may determine the PDN during network entry 206, 208, and may send a message to the AAA server indicating which PDN gateway 140 or APN the mobile station 128 will be associated with, according to an example embodiment. The AAA server 202 may send an access accept (APN) message 226 accepting the APN, according to an example embodiment.

FIG. 3A is a block diagram showing a dynamic service addition (DSA) message 302 according to an example embodiment. The DSA message 302 may, for example, include a DSA request 214 or a DSA response 216. The DSA message 302 may, for example, include a medium access control (MAC) header 304, a payload 306, and a cyclic redundancy check (CRC) 308. The MAC header 304 may include a header type field 310, indicating, for example, that the DSA message 302 is a generic MAC header. The MAC header 304 may also include an encryption control field 312, described in paragraph [0047], a connection identifier (CID) field 314, and a header check sequence (HCS) field 316.

The encryption control field 312 may include a encryption control (EC) subfield 318 indicating whether the payload 306 is encrypted, a type subfield 320 indicating, for example, that the payload 306 includes a PDN, a CRC indicator subfield 322 indicating whether the CRC 308 is included in the DSA message 302, an encryption key sequence (EKS) subfield 324 indicating an index of a traffic encryption key (TEK) and initialization vector used to encrypt the payload 306 if the EC subfield 318 indicated that the payload 306 is encrypted, and a length subfield 326 indicating a length of the DSA message 302.

FIG. 3B is a block diagram showing the payload 306 included in the DSA message 302 of FIG. 3A according to an example embodiment. In this example, the payload 306 may include a management message type field 328 indicating whether the DSA message 302 is a DSA request 214 or a DSA response 216. The payload 306 may also include a transaction ID field 330 indicating the transaction in which either the DSA request 214 or DSA response 216 includes the PDN. If the DSA message 302 includes a DSA response 216, the payload 306 may include a confirmation code 332 for the entire corresponding DSA request 214. The payload 306 may also include type/length/value encoded information 334, which may include the PDN.

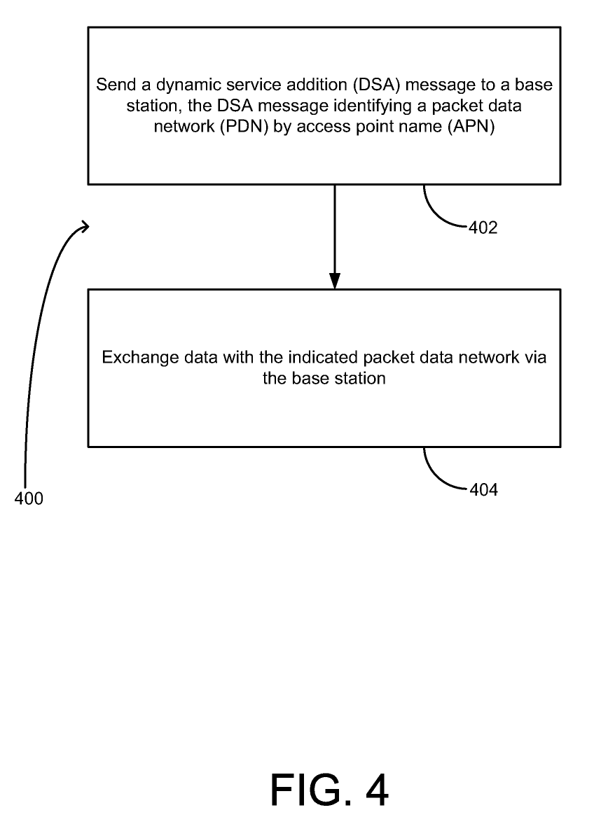

FIG. 4 is a flowchart showing a method 400 according to an example embodiment. In this example, the method 400 may include sending, by a mobile station in a wireless network, a dynamic service addition (DSA) message to a base station, the DSA message identifying a packet data network (PDN) by access point name (APN) (402). The method 400 may also include exchanging data with the indicated packet data network via the base station (404).

In an example embodiment, the sending (402) may include sending, by the mobile station in a Worldwide interoperability for Microwave Access (WiMAX) network, the dynamic service addition message to the base station.

In an example embodiment, the method 400 may further include entering the wireless network. The entering may including synchronizing with the base station, establishing transmission timing and transmission power for communication with the base station, negotiating modulation schemes with the base station, authenticating the mobile station to the base station, registering the mobile station with the base station, and acquiring an Internet Protocol (IP) address from the base station.

In an example embodiment, the sending (402) may include sending, by the mobile station in the wireless network, the DSA message to the base station, the DSA message including a DSA request, the DSA request including a medium access control (MAC) header, a payload including the APN, and a cyclic redundancy check (CRC).

In an example embodiment, the sending (402) may include sending the DSA message from the mobile station to the base station in response to receiving a DSA request from the base station, the DSA message including a DSA response, the DSA response including a medium access control (MAC) header, a payload including the APN, and a cyclic redundancy check (CRC).

In an example embodiment, the sending (402) may include sending, by the mobile station in the wireless network, the DSA message to the base station, the DSA message including a medium access control (MAC) header, a payload including a management message type field identifying the DSA message as either a DSA request or a DSA response, a transaction ID field identifying a transaction which includes the DSA message, and the APN, and a cyclic redundancy check (CRC).

In an example embodiment, the method 400 may further include receiving input from a user, and determining the APN based on the input.

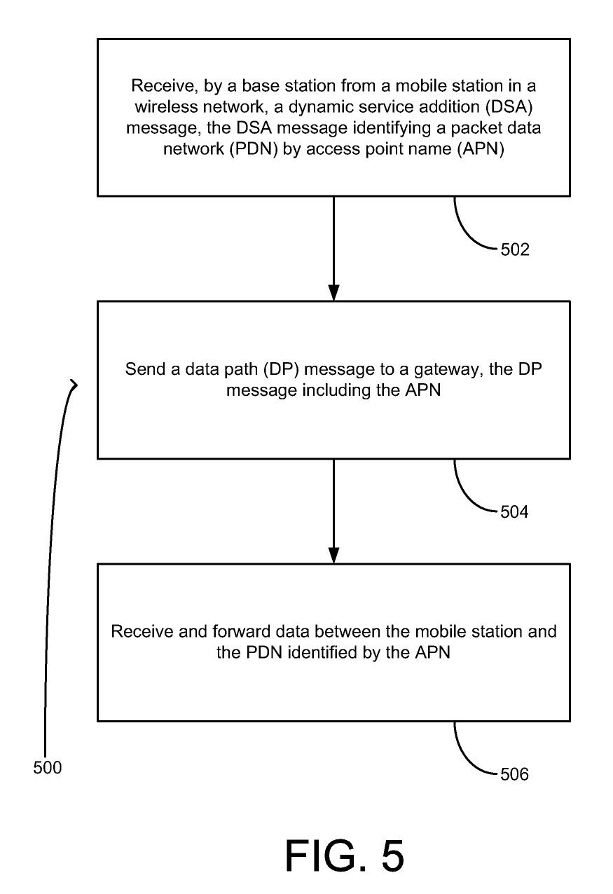

FIG. 5 is a flowchart showing a method 500 according to another example embodiment. In this example, the method 500 may include receiving, by a base station from a mobile station in a wireless network, a dynamic service addition (DSA) message, the DSA message identifying a packet data network (PDN) by access point name (APN) (502). The method 500 may also include sending a data path (DP) message to a gateway, the DP message including the APN (504). The method 500 may also include receiving and forwarding data between the mobile station and the PDN identified by the APN (506).

In an example embodiment, the receiving and forwarding the data (506) may include receiving and forwarding the data between the mobile station and the identified PDN via the gateway.

In an example embodiment, the method 500 may further include initializing the mobile station. The initializing may including allocating at least one connection identifier (CID) to the mobile station, negotiating at least one modulation scheme with the mobile station, authorizing the mobile station to operate in the wireless network, registering the mobile station in the wireless network, and assigning an Internet Protocol (IP) message to the mobile station.

In an example embodiment, the receiving the DSA message (502) may include receiving a DSA request from the mobile station, the DSA request identifying the PDN by the APN. In this example, the method 500 may further include, in response to receiving the DSA request from the mobile station, sending a data path (DP) request to the gateway, the DP request including the APN. The method 500 may further include receiving a DP response from the gateway. The method 500 may further include, in response to receiving the DP response from the gateway, sending a DSA response to the mobile station.

In an example embodiment, the receiving the DSA message (502) may include receiving a DSA response from the mobile station, the DSA response identifying the PDN by the APN. In this example, the method 500 may further include receiving a data path (DP) request from the gateway. The method 500 may further include, in response to receiving the DP request from the gateway, sending a DSA request to the mobile station. The method 500 may further include, in response to receiving the DSA response from the mobile station, sending a DP response to the gateway, the DP response including the APN.

In an example embodiment, the method 500 may further include establishing a Generic Routing Encapsulation (GRE) tunnel with the gateway.

In an example embodiment, the receiving (502) may include receiving, by the base station in the wireless network, the DSA message from the mobile station, the DSA message including a DSA request, the DSA request including a medium access control (MAC) header, a payload including the APN, and a cyclic redundancy check (CRC).

In an example embodiment, the receiving (502) may include receiving, by the base station in the wireless network, the DSA message from the mobile station, the DSA message including a DSA response, the DSA response including a medium access control (MAC) header, a payload including the APN, and a cyclic redundancy check (CRC).

In an example embodiment, the receiving (502) may include receiving, by the base station in the wireless network, the DSA message from the mobile station. In this example, the DSA message may include a medium access control (MAC) header, a payload including a management message type field identifying the DSA message as either a DSA request or a DSA response, a transaction ID field identifying a transaction which includes the DSA message, and the APN, and a cyclic redundancy check (CRC).

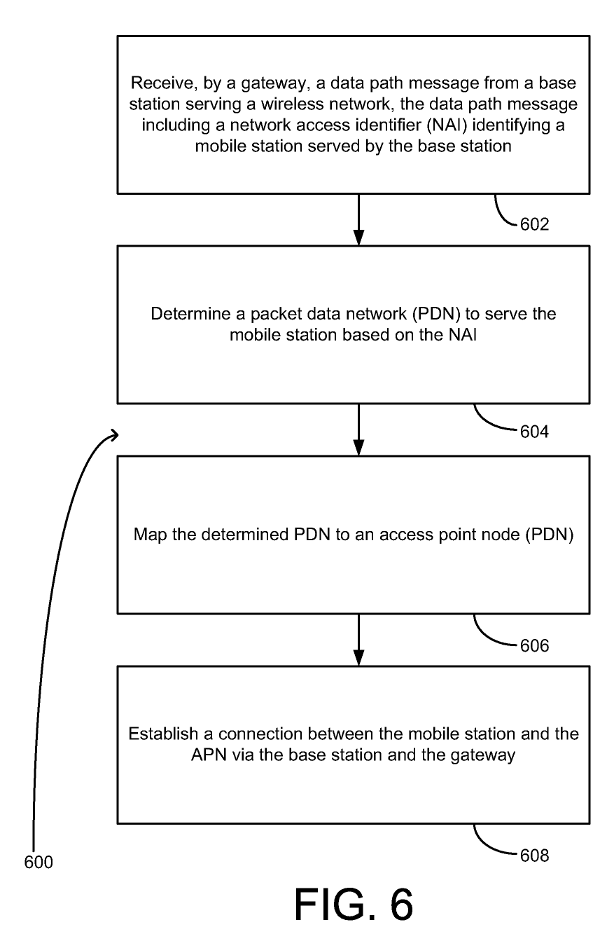

FIG. 6 is a flowchart showing a method 600 according to another example embodiment. In an example embodiment, the method 600 may include receiving, by a gateway, a data path message from a base station serving a wireless network, the data path message including a network access identifier (NAI) identifying a mobile station served by the base station (602). The method 600 may further include determining a packet data network (PDN) to serve the mobile station based on the NAI (604). The method 600 may further include mapping the determined PDN to an access point node (APN) (606). The method 600 may further include establishing a connection between the mobile station and the APN via the base station and the gateway (608).

In an example embodiment, the receiving (602) may include receiving, by the gateway, the data path message from the base station, the base station including a Worldwide interoperability for Microwave Access (WiMAX) base station serving a WiMAX network.

In an example embodiment, the determining (604) may include determining the PDN to serve the mobile station based on the NAI, the PDN including an Internet.

In an example embodiment, the determining (604) may include determining the PDN to serve the mobile station based on the NAI, the PDN including an enterprise network.

In an example embodiment, the determining (604) may include determining the PDN to serve the mobile station based on the NAI, the PDN including an Internet Protocol Multimedia System (IMS) network.

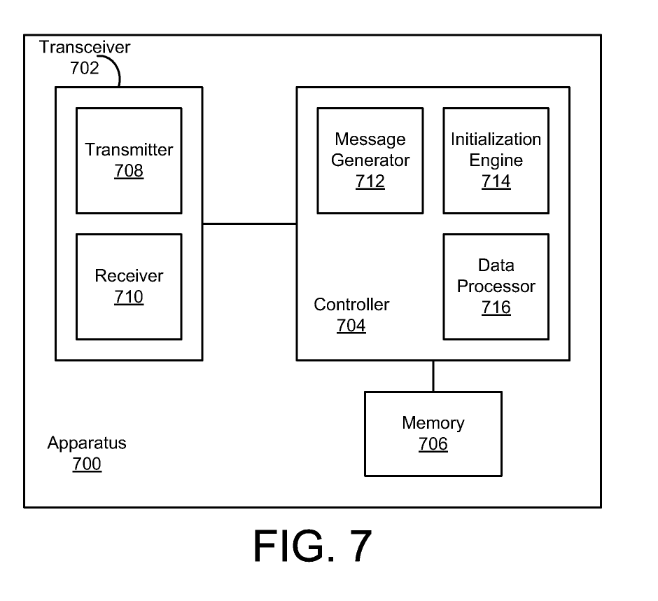

FIG. 7 is a block diagram showing an apparatus 700 according to an example embodiment. The apparatus may include, for example, a mobile station 122, 124, 126, 128, a base station 118, 120, or an ASN gateway 132, 134, which may perform any or all of the functions described above. In this example, the apparatus 700 may include a transceiver 702, a controller 704, and a memory 706. The transceiver 702, which may include a transmitter 708 and/or receiver 710 as separate components or included in a single device, may transmit and/or receive messages via a wired or wireless interface. The controller 704 may include a message generator 712 configured to generate any or all of the messages described above, an initialization engine 714 configured to perform any or all of the network entry or initialization processes described above, and/or a data processor 716 configured to process data and/or make determinations as described above. The memory 706 may store information and/or data as described above.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

What is claimed is:

1. A method comprising:
sending, by a mobile station in a wireless network, a dynamic service addition (DSA) message to a base station, the DSA message identifying a packet data network (PDN) by access point name (APN); and
exchanging data with the indicated packet data network via the base station.

2. The method of claim 1, wherein the sending includes sending, by the mobile station in a Worldwide interoperability for Microwave Access (WiMAX) network, the dynamic service addition message to the base station.

3. The method of claim 1, wherein the method further includes entering the wireless network, the entering including:
synchronizing with the base station;
establishing transmission timing and transmission power for communication with the base station;
negotiating modulation schemes with the base station;
authenticating the mobile station to the base station;
registering the mobile station with the base station; and
acquiring an Internet Protocol (IP) address from the base station.

4. The method of claim 1, wherein the sending includes sending, by the mobile station in the wireless network, the DSA message to the base station, the DSA message including a DSA request, the DSA request including a medium access control (MAC) header, a payload including the APN, and a cyclic redundancy check (CRC).

5. The method of claim 1, wherein the sending includes sending the DSA message from the mobile station to the base station in response to receiving a DSA request from the base station, the DSA message including a DSA response, the DSA response including a medium access control (MAC) header, a payload including the APN, and a cyclic redundancy check (CRC).

6. The method of claim 1, wherein the sending includes sending, by the mobile station in the wireless network, the DSA message to the base station, the DSA message including:
a medium access control (MAC) header;
a payload including a management message type field identifying the DSA message as either a DSA request or a DSA response, a transaction ID field identifying a transaction which includes the DSA message, and the APN; and
a cyclic redundancy check (CRC).

7. The method of claim 1, further comprising:
receiving input from a user; and
determining the APN based on the input.

8. An apparatus comprising:
a controller configured to:
generate a dynamic service addition (DSA) message, the DSA message identifying a packet data network (PDN) by access point name (APN); and
process data to be exchanged with the indicated packet data network via a base station
a wireless transceiver configured to send the DSA message to the base station and to send and receive the data to and from the base station; and
a memory.

9. The apparatus of claim 8, wherein the transceiver is configured to send the dynamic service addition message to the base station, the base station including a Worldwide interoperability for Microwave Access (WiMAX) base station.

10. The apparatus of claim 8, wherein the processor is further to perform initialization upon entering the wireless network, the initialization including:
synchronize with the base station based on a frame preamble received by the transceiver from the base station;
establish transmission timing and transmission power for communication with the base station;
negotiate modulation schemes with the base station;
authenticate the mobile station to the base station;
register the mobile station with the base station; and
acquire an Internet Protocol (IP) address from the base station.

11. The apparatus of claim 8, wherein the controller is configured to generate the DSA message, the DSA message including a DSA request, the DSA request including a medium access control (MAC) header, a payload including the APN, and a cyclic redundancy check (CRC).

12. The apparatus of claim 8, wherein the controller is configured to generate the DSA message in response to the apparatus receiving a DSA request from the base station, the DSA message including a DSA response, the DSA response including a medium access control (MAC) header, a payload including the APN, and a cyclic redundancy check (CRC).

13. The apparatus of claim 8, wherein the controller is configured to generate the DSA message, the DSA message including:
a medium access control (MAC) header;
a payload including a management message type field identifying the DSA message as either a DSA request or a DSA response, a transaction ID field identifying a transaction which includes the DSA message, and the APN; and
a cyclic redundancy check (CRC).

14. The apparatus of claim 8, further comprising:
an input configured to receive input from a user
wherein the processor is configured to determine the APN based on the input.

15. A method comprising:
receiving, by a base station from a mobile station in a wireless network, a dynamic service addition (DSA) message, the DSA message identifying a packet data network (PDN) by access point name (APN);
sending a data path (DP) message to a gateway, the DP message including the APN; and
receiving and forwarding data between the mobile station and the PDN identified by the APN.

16. The method of claim 15, wherein the receiving and forwarding the data includes receiving and forwarding the data between the mobile station and the identified PDN via the gateway.

17. The method of claim 15, further comprising initializing the mobile station, the initializing including:
allocating at least one connection identifier (CID) to the mobile station;
negotiating at least one modulation scheme with the mobile station;
authorizing the mobile station to operate in the wireless network;
registering the mobile station in the wireless network; and
assigning an Internet Protocol (IP) message to the mobile station.

18. The method of claim 15, wherein:
the receiving the DSA message includes receiving a DSA request from the mobile station, the DSA request identifying the PDN by the APN; and
the method further includes:
in response to receiving the DSA request from the mobile station, sending a data path (DP) request to the gateway, the DP request including the APN;
receiving a DP response from the gateway; and
in response to receiving the DP response from the gateway, sending a DSA response to the mobile station.

19. The method of claim 15, wherein:
the receiving the DSA message includes receiving a DSA response from the mobile station, the DSA response identifying the PDN by the APN; and
the method further includes:
receiving a data path (DP) request from the gateway;
in response to receiving the DP request from the gateway, sending a DSA request to the mobile station; and
in response to receiving the DSA response from the mobile station, sending a DP response to the gateway, the DP response including the APN.

20. The method of claim 15, further including establishing a Generic Routing Encapsulation (GRE) tunnel with the gateway.

21. The method of claim 15, wherein the receiving includes receiving, by the base station in the wireless network, the DSA message from the mobile station, the DSA message including a DSA request, the DSA request including a medium access control (MAC) header, a payload including the APN, and a cyclic redundancy check (CRC).

22. The method of claim 15, wherein the receiving includes receiving, by the base station in the wireless network, the DSA message from the mobile station, the DSA message including a DSA response, the DSA response including a medium access control (MAC) header, a payload including the APN, and a cyclic redundancy check (CRC).

23. The method of claim 15, wherein the receiving includes receiving, by the base station in the wireless network, the DSA message from the mobile station, the DSA message including:
a medium access control (MAC) header;
a payload including a management message type field identifying the DSA message as either a DSA request or a DSA response, a transaction ID field identifying a transaction which includes the DSA message, and the APN; and
a cyclic redundancy check (CRC).

24. An apparatus comprising:
a controller configured to:
process a dynamic service addition (DSA) message, the DSA message identifying a packet data network (PDN) by access point name (APN); and
based on processing the DSA message, generate a data path (DP) message to a gateway, the DP message including the APN; and
receive and forward data between a mobile station and the PDN identified by the APN;
a transceiver configured to:
receive the DSA message from the mobile station and receive and send data from and to the mobile via a wireless interface; and
receive and send data from and to the PDN; and
a memory.

25. The apparatus of claim 24, wherein the controller and transceiver are configured to receive and forward the data between the mobile station and the PDN via the gateway.

26. The apparatus of claim 24, wherein the controller is configured to initialize the mobile station into a Worldwide interoperability for Microwave Access (WiMAX) network served by the apparatus, the initializing including:
allocating at least one connection identifier (CID) to the mobile station;
negotiating at least one modulation scheme with the mobile station;
authorizing the mobile station to operate in the wireless network;
registering the mobile station in the wireless network; and
assigning an Internet Protocol (IP) message to the mobile station.

27. The apparatus of claim 24, wherein the controller is configured to:
process the DSA message, the DSA message including a DSA request identifying the PDN by the APN;
generate, based on processing the DSA request, a data path (DP) request for the transceiver to send to the gateway, the DP request including the APN;
process a DP response received by the transceiver from the gateway; and
based on processing the DP response received from the gateway, generate a DSA response for the transceiver to send to the mobile station.

28. The apparatus of claim 24, wherein the controller is configured to:
process the DSA message, the DSA message including a DSA response identifying the PDN by the APN;
process a data path (DP) request received by the transceiver from the gateway;
based on processing the DP request received from the gateway, generate a DSA request for the transceiver to send the mobile station; and
based on processing the DSA response from the mobile station, generate a DP response for the transceiver to send to the gateway, the DP response including the APN.

29. The apparatus of claim 24, wherein the controller is further configured to establish a Generic Routing Encapsulation (GRE) tunnel with the gateway.

30. The apparatus of claim 24, wherein the controller is configured to process DSA message, the DSA message including a DSA request, the DSA request including a medium access control (MAC) header, a payload including the APN, and a cyclic redundancy check (CRC).

31. The apparatus of claim 24, wherein the controller is configured to process, the DSA message, the DSA message including a DSA response, the DSA response including a medium access control (MAC) header, a payload including the APN, and a cyclic redundancy check (CRC).

32. The apparatus of claim 24, wherein the controller is configured to process the DSA message, the DSA message including:
a medium access control (MAC) header;
a payload including a management message type field identifying the DSA message as either a DSA request or a DSA response, a transaction ID field identifying a transaction which includes the DSA message, and the APN; and
a cyclic redundancy check (CRC).

33. A method comprising:
receiving, by a gateway, a data path message from a base station serving a wireless network, the data path message including a network access identifier (NAI) identifying a mobile station served by the base station;
determining a packet data network (PDN) to serve the mobile station based on the NAI;
mapping the determined PDN to an access point node (APN); and
establishing a connection between the mobile station and the APN via the base station and the gateway.

34. The method of claim 33, wherein the receiving includes receiving, by the gateway, the data path message from the base station, the base station including a Worldwide interoperability for Microwave Access (WiMAX) base station serving a WiMAX network.

35. The method of claim 33, wherein the determining includes determining the PDN to serve the mobile station based on the NAI, the PDN including an Internet.

36. The method of claim 33, wherein the determining includes determining the PDN to serve the mobile station based on the NAI, the PDN including an enterprise network.

37. The method of claim 33, wherein the determining includes determining the PDN to serve the mobile station based on the NAI, the PDN including an Internet Protocol Multimedia System (IMS) network.
